(19) United States
(12) Patent Application Publication
(10) Pub. No.: US 2012/0107031 A1
(43) Pub. Date: May 3, 2012

(54) JOB INDEX PRINTED ON A CONTINUOUS FEED ROLL

(75) Inventors: Barry K. Ayash, Webster, NY (US); Adam A. Gierczak, Rochester, NY (US); Kevin St. Martin, Rochester, NY (US)

(73) Assignee: XEROX CORPORATION, NORWALK, CT (US)

(21) Appl. No.: 12/938,550

(22) Filed: Nov. 3, 2010

(51) Int. Cl. B41J 11/42

(52) U.S. Cl. 400/582

(57) ABSTRACT

An apparatus and associated method move a web of “input continuous media” along at least one media path of a continuous printing device. The method prints markings on the input continuous media to create a web of “printed continuous media” using at least one printing engine of the continuous printing device. The method holds the printed continuous media on at least one output media roll of the continuous printing device after printing the markings on the input continuous media. The output media roll is supported by an output media roll support. The method also determines when the output media roll comprises a “completed printed roll” of printed continuous media and is ready to be cut by a cutter of the continuous printing device, and the output media roll is ready to be removed from the output media roll support. If the output media roll comprises a completed printed roll, the method prints an “index of items” that were printed on the completed printed roll using the printing engine as the last item printed on the completed printed roll before the cutter cuts the printed continuous media is supplied to the completed printed roll and before the completed printed roll is removed from the output media roll support. The index of items is visible from the exterior of the completed printed roll after the completed printed roll is removed from the output media roll support.

### BACKGROUND

Embodiments herein generally relate to continuous feed printers and more particularly to an improved printer and method that automatically provides a printed index on the exterior of a completed printed roll.

There are many different types of printing devices currently available. Some printing devices print on cut sheets of media, while others print from a continuous roll of media (often referred to as a web of material). Some continuous feed printers cut the printed output into individual sheets of media, while others wind the printed media onto an output roll (often referred to as a rewind roll).

When viewing such printed rolls that were printed using a continuous feed printer, there is no easy way to tell what was printed on each roll, unless the customer is willing to use a post-processing device to unroll the continuous feed roll or is willing to adhere a label on the roll (which may fall off).

### SUMMARY

In view of the foregoing, one exemplary method embodiment herein moves a web of “input continuous media” along at least one media path of a continuous printing device. The method prints markings on the input continuous media to create a web of “printed continuous media” using at least one printing engine of the continuous printing device. The method holds the printed continuous media on at least one output media roll of the continuous printing device after printing the markings on the input continuous media. The output media roll is supported by an output media roll support. The method also determines when the output media roll comprises a “completed printed roll” of printed continuous media and is ready to be cut by a cutter of the continuous printing device, and the output media roll is ready to be removed from the output media roll support.

If the output media roll comprises a completed printed roll, the method prints an “index of items” that were printed on the completed printed roll using the printing engine as the last item printed on the completed printed roll before the cutter cuts the printed continuous media being supplied to the completed printed roll and before the completed printed roll is removed from the output media roll support. The index of items is visible from the exterior of the completed printed roll after the completed printed roll is removed from the output media roll support.

Also, the index of items includes human readable markings and/or machine-readable markings. The method can store the index of items in a non-volatile computer readable storage media of the continuous printing device as the items are printed on the input continuous media. The index of items comprises a print job that is separate from other print jobs included within the completed printed roll.

A continuous printing device embodiment herein comprises at least one input media roll support that holds an input media roll of input continuous media. The structure includes at least one media path positioned adjacent to the input media roll support. The input continuous media moves along the media path. Further, at least one printing engine is positioned along the media path. This printing engine prints markings on the input continuous media to create printed continuous media. The structure also includes at least one output media roll support positioned adjacent to the media path. The output media roll support holds an output media roll of the printed continuous media. The structure further includes a cutter positioned along the media path. The cutter cuts the printed continuous media.

Also, a controller is operatively connected to (directly or indirectly connected to) the printing engine and the cutter. A non-volatile computer readable storage media is also operatively connected to the controller. The controller stores the index of items in the non-volatile computer readable storage media as the items are printed on the input continuous media.

The controller determines when the output media roll comprises a “completed printed roll” of printed continuous media (such a completed printed roll is one that is ready to be cut by the cutter) and when the output media roll is ready to be removed from the output media roll support.

If the output media roll comprises a completed printed roll, the controller causes the printing engine to print an index of items that were printed on the completed printed roll as the last item printed on the completed printed roll before the cutter cuts the printed continuous media being supplied to the completed printed roll and before the completed printed roll is removed from the output media roll support.

The index of items is visible from the exterior of the completed printed roll after the completed printed roll is removed from the output media roll support. Further, the index of items comprises human readable markings and/or machine-readable markings.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a side-view schematic diagram of a device according to embodiments herein;

FIG. 2 is a perspective-view schematic diagram of a roll according to embodiments herein;

FIG. 3 is a schematic diagram of an index according to embodiments herein; and

FIG. 4 is a flowchart illustrating different method embodiments herein.

### DETAILED DESCRIPTION

As mentioned above, it is difficult to know the print jobs contained within a printed roll of media. Unrolling the printed roll requires additional machinery and is time and labor intensive. Producing labels that are attached or adhered to the roll requires a separate print job and different forms of print media (such as self-adhesive media). Further, such labels can easily become detached from the roll, potentially leaving the roll unlabeled. In view of such issues, the embodiments herein provide automated systems and methods that automatically provide a permanent index of the different print jobs that are contained within a completed printed roll. More specifically, the embodiments print an index of items printed within the roll as the last print job of the roll. By printing the index directly on the roll, the embodiments herein provide a completely automatic system (that does not require additional user input to proceed) and provide a label that is a permanent part of the roll and that will not become separated from the roll. Further, with embodiments herein, the label does not need to be separately printed and later attached, thereby avoiding the time and labor associated with such activities.

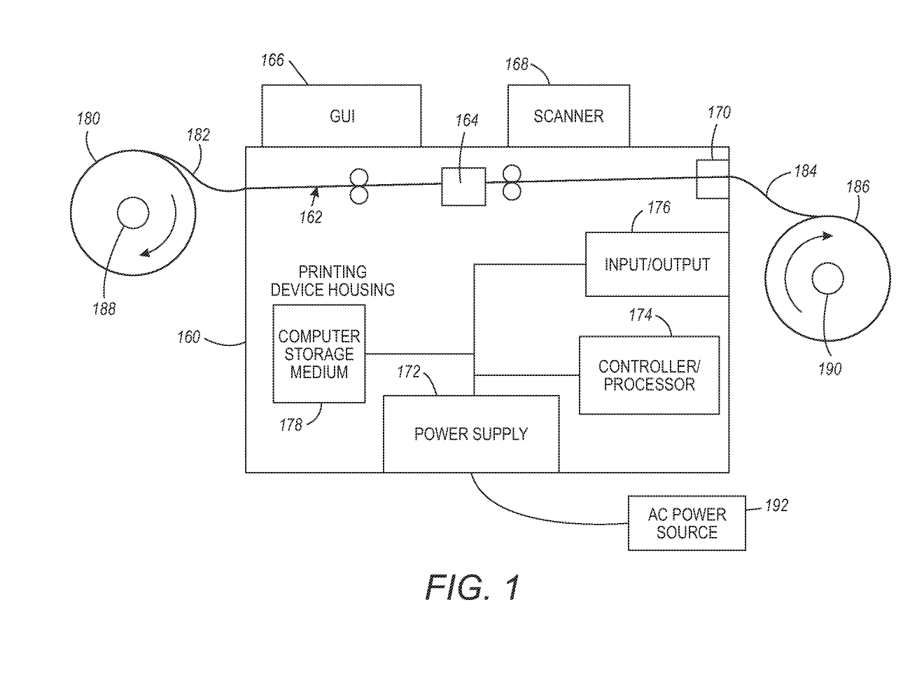

One exemplary continuous printing device embodiment is shown in FIG. 1. This exemplary printing device 160 includes at least one input media roll support 188 that holds an input media roll 180 of input continuous media 182. The structure includes at least one media path 162 positioned adjacent to the input media roll support 188. The input continuous media 182 moves along the media path 162. Further, at least one printing engine 164 is positioned along the media path 162. This printing engine 164 prints markings on the input continuous media 182 to create printed continuous media 184. The structure also includes at least one output media roll support 190 positioned adjacent to the media path 162. The output media roll support 190 holds an output media roll 186 of the printed continuous media 184. The structure further includes a cutter 170 positioned along the media path 162. The cutter 170 cuts the printed continuous media 184.

The printing device 160 can comprise, for example, a printer, copier, multi-function machine, etc., which can include a controller/processor 174. The at least one marking device (printing engine) 164 is operatively connected to the processor 174 and a communications port (input/output) 176 is operatively connected to the processor 174 and potentially to a computerized network external to the printing device.

Further, the printing device 160 can include at least one accessory functional component (such as a scanner/document handler 166) and graphic user interface assembly 168 that operate on the power supplied from the external power source 182 (through the power supply 172). The power supply 172 connects to an external alternating current power source 192 and converts the external power into the type of power needed by the various components.

The processor 174 controls the various actions of the printing device 160. A non-volatile computer storage medium 178 (which can be optical, magnetic, capacitor based, etc.) is readable by the processor 174 and stores instructions that the processor 174 executes to allow the printing device 160 to perform its various functions, such as those described herein.

Also, the controller 174 is operatively connected to (directly or indirectly connected to) the printing engine(s) 164 and the cutter 170. The controller 174 stores the index of items in the non-volatile computer readable storage media 178 as the items are printed on the input continuous media 182.

The controller 174 determines when the output media roll 186 comprises a “completed printed roll” of printed continuous media 184 (such a completed printed roll is one that is ready to be cut by the cutter 170) and when the output media roll 186 is ready to be removed from the output media roll support 190. For example, the output media roll 186 could be considered to be a complete printed roll when it reaches some predetermined radius or diameter. Alternatively, the output media roll 186 could be considered a completed printed roll when a certain portion of a print job, or jobs, have been printed onto the printed continuous media 184.

If the output media roll 186 comprises a completed printed roll, the controller 174 causes the printing engine(s) 164 to print an index of items 200 that were printed on the completed printed roll as the last item printed on the completed printed roll before the cutter 170 cuts the printed continuous media 184 being supplied to the completed printed roll and before the completed printed roll is removed from the output media roll support 190. More specifically, the controller 174 composes a separate print job listing all the jobs printed on the printed continuous media 184 on the output media roll 186. This job listing print job is then sent to the printer and is the last job printed on the output media roll 186.

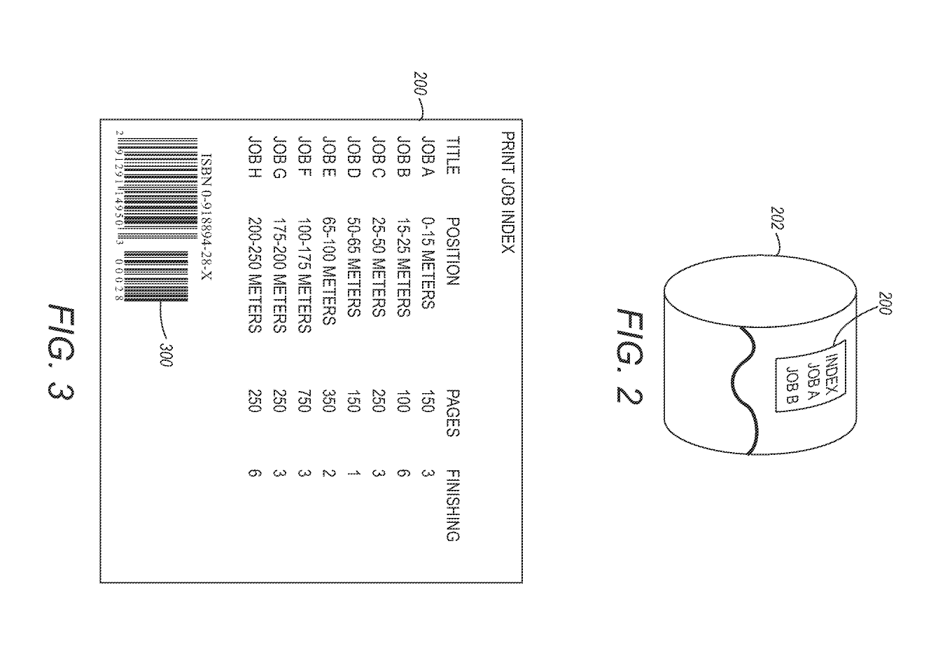

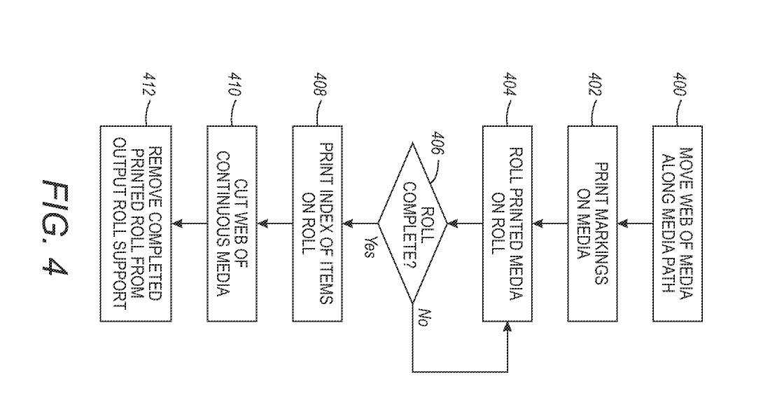

As shown in FIG. 2, the index of items 200 is visible from the exterior of a completed printed roll 202 after the completed printed roll 202 has been removed from the output media roll support 190. This final print job is a job index of all jobs printed with different properties such as copy count, post finishing requirements, and any other information that may be important to the end user. Further, as shown in FIG. 3, the index of items 200 comprises human readable markings and/or machine-readable markings 300, such as bar codes or glyphs. The machine readable markings 300 allow users to scan each roll for better inventory control. This allows customers who print and store rolls of paper to keep better inventory of the job printed on each roll and reduces confusion as to what has been printed on each roll.

FIG. 4 is a flow diagram illustrating various method embodiments herein. More specifically, in item 400 one exemplary method embodiment herein moves a web of “input continuous media” along at least one media path of a continuous printing device. The method prints markings on the input continuous media to create a web of “printed continuous media” using at least one printing engine of the continuous printing device in item 402. The method then rolls or holds the printed continuous media on at least one output media roll of the continuous printing device after printing the markings on the input continuous media in item 404. The output media roll is supported by an output media roll support.

In item 406, the method determines whether the output media roll comprises a “completed printed roll” of printed continuous media. As mentioned above, this determination can be made depending upon whether the diameter/radius has reached a certain size, whether all print jobs have finished, etc. If the roll is not yet complete, the printed continuous media continues to be added to the roll in item 404.

However, when the roll is a completed printed roll (and is ready to be cut by the cutter of the continuous printing device and is ready to be removed from the output media roll support) the method prints an “index of items” that were printed on the completed printed roll using the printing engine as the last item printed on the completed printed roll in item 408. This is done before the cutter cuts the printed continuous media that is supplied to the completed printed roll (item 410) and before the completed printed roll is removed from the output media roll support (item 412). Because it is the last item printed on the completed printed roll, the index of items is visible from the exterior of the completed printed roll and is clearly visible after the completed printed roll is removed from the output media roll support.

As mentioned above, the index of items can include human readable markings and/or machine-readable markings. The method can store the index of items in a non-volatile computer readable storage media of the continuous printing device as the items are printed on the input continuous media. Further, the index of items comprises a print job that is separate from other print jobs included within the completed printed roll.

By printing the index directly on the roll, the embodiments herein provide a completely automatic system and provide a label that is a permanent part of the roll and that will not become separated from the roll. Further, with embodiments herein, the label does not need to be separately printed and later attached, thereby avoiding the time and labor associated with such activities.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A continuous printing device comprising:
at least one input media roll support that holds an input media roll of input continuous media;
at least one media path positioned adjacent to said input media roll support, said input continuous media moving along said media path;
at least one printing engine positioned along said media path, said printing engine printing markings on said input continuous media to create printed continuous media;
at least one output media roll support positioned adjacent to said media path, said output media roll support holding an output media roll of said printed continuous media; and
a controller operatively connected to said printing engine,
said controller determining when said output media roll comprises a completed printed roll of said printed continuous media and said output media roll is ready to be removed from said output media roll support, and
if said output media roll comprises said completed printed roll, said controller causes said printing engine to print an index of items that were printed on said completed printed roll as the last item printed on said completed printed roll before said completed printed roll is removed from said output media roll support.

2. The continuous printing device according to claim 1, said index of items being visible from an exterior of said completed printed roll after said completed printed roll is removed from said output media roll support.

3. The continuous printing device according to claim 1, said index of items comprising at least one of human readable markings and machine-readable markings.

4. The continuous printing device according to claim 1, further comprising a non-volatile computer readable storage media operatively connected to said controller, said controller storing said index of items in said non-volatile computer readable storage media as said items are printed on said input continuous media.

5. The continuous printing device according to claim 1, said index of items comprising a print job separate from other print jobs included within said completed printed roll.

6. A continuous printing device comprising:
at least one input media roll support that holds an input media roll of input continuous media;
at least one media path positioned adjacent to said input media roll support, said input continuous media moving along said media path;
at least one printing engine positioned along said media path, said printing engine printing markings on said input continuous media to create printed continuous media;
at least one output media roll support positioned adjacent to said media path, said output media roll support holding an output media roll of said printed continuous media;
a cutter positioned along said media path, said cutter cutting said printed continuous media; and
a controller operatively connected to said printing engine and said cutter,
said controller determining when said output media roll comprises a completed printed roll of said printed continuous media and is ready to be cut by said cutter of said, and said output media roll is ready to be removed from said output media roll support, and
if said output media roll comprises said completed printed roll, said controller causes said printing engine to print an index of items that were printed on said completed printed roll as the last item printed on said completed printed roll before said cutter cuts said printed continuous media being supplied to said completed printed roll and before said completed printed roll is removed from said output media roll support.

7. The continuous printing device according to claim 6, said index of items being visible from an exterior of said completed printed roll after said completed printed roll is removed from said output media roll support.

8. The continuous printing device according to claim 6, said index of items comprising at least one of human readable markings and machine-readable markings.

9. The continuous printing device according to claim 6, further comprising a non-volatile computer readable storage media operatively connected to said controller, said controller storing said index of items in said non-volatile computer readable storage media as said items are printed on said input continuous media.

10. The continuous printing device according to claim 6, said index of items comprising a print job separate from other print jobs included within said completed printed roll.

11. A method comprising:
moving a web of input continuous media along at least one media path of a continuous printing device;
printing markings on said input continuous media to create a web of printed continuous media using at least one printing engine of said continuous printing device;
holding said printed continuous media on at least one output media roll of said continuous printing device after printing said markings on said input continuous media, said output media roll being supported by an output media roll support;
determining when said output media roll comprises a completed printed roll of said printed continuous media and when said output media roll is ready to be removed from said output media roll support; and
if said output media roll comprises said completed printed roll, printing an index of items that were printed on said completed printed roll using said printing engine as the last item printed on said completed printed roll before said completed printed roll is removed from said output media roll support.

12. The method according to claim 11, said index of items being visible from an exterior of said completed printed roll after said completed printed roll is removed from said output media roll support.

13. The method according to claim 11, said index of items comprising at least one of human readable markings and machine-readable markings.

14. The method according to claim 11, further comprising storing said index of items in a non-volatile computer readable storage media of said continuous printing device as said items are printed on said input continuous media.

15. The method according to claim 11, said index of items comprising a print job separate from other print jobs included within said completed printed roll.

16. A method comprising:
moving a web of input continuous media along at least one media path of a continuous printing device;
printing markings on said input continuous media to create a web of printed continuous media using at least one printing engine of said continuous printing device;
holding said printed continuous media on at least one output media roll of said continuous printing device after printing said markings on said input continuous media, said output media roll being supported by an output media roll support;
determining when said output media roll comprises a completed printed roll of said printed continuous media and is ready to be cut by a cutter of said continuous printing device, and when said output media roll is ready to be removed from said output media roll support; and
if said output media roll comprises said completed printed roll, printing an index of items that were printed on said completed printed roll using said printing engine as the last item printed on said completed printed roll before said cutter cuts said printed continuous media being supplied to said completed printed roll and before said completed printed roll is removed from said output media roll support.

17. The method according to claim 16, said index of items being visible from an exterior of said completed printed roll after said completed printed roll is removed from said output media roll support.

18. The method according to claim 16, said index of items comprising at least one of human readable markings and machine-readable markings.

19. The method according to claim 16, further comprising storing said index of items in a non-volatile computer readable storage media of said continuous printing device as said items are printed on said input continuous media.

20. The method according to claim 16, said index of items comprising a print job separate from other print jobs included within said completed printed roll.
